(19) United States
(12) Patent Application Publication
(10) Pub. No.: US 2009/0181284 A1
(43) Pub. Date: Jul. 16, 2009

(54) SEALING STRUCTURE FOR A BIPOLAR PLATE OF A FUEL CELL

(75) Inventors: Fang Bor WENG, Jhongli City (TW); Su Ay, Jhongli City (TW); Chun-Ying Hsu, Jhongli City (TW); Chih-Hung Lee, Jhongli City (TW)

Correspondence Address: EGBERT LAW OFFICES, 412 MAIN STREET, 7TH FLOOR, HOUSTON, TX, 77002, US

(73) Assignee: YUAN ZE UNIVERSITY, Jhongli City (TW)

(21) Appl. No.: 12/013,459

(22) Filed: Jan. 13, 2008

(51) Int. Cl. H01M 8/02

(52) U.S. Cl. 429/35

(57) ABSTRACT

The present invention provides a sealing structure for a bipolar plate of a fuel cell. The sealing structure includes a plurality of bipolar plates and a gas guidance and reaction layer. A gas channel is placed laterally onto the bipolar plate corresponding to the gas guidance and reaction layer. A gasket is located between a bipolar plate and the gas guidance and reaction layer. A permeable portion is formed on the gasket corresponding to the gas channel. A concave surface is placed laterally on the bipolar plate corresponding to the gas guidance and reaction layer for mating with the gasket. When the bipolar plate, gas guidance and reaction layer and gasket are fastened, the deformation amount of the gasket is accurately controlled through the height limitation of the concave surface.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fuel cell, and more particularly to an innovative fuel cell with a sealing structure for the coupling portion of the bipolar plate.

2. Description of Related Art

Including Information Disclosed Under 37 CFR 1.97 and 37 CFR 1.98.

As far as a common fuel cell is concerned, the bipolar plate is a structure arranged at both sides of the membrane electrode assembly (MEA). The bipolar plate is made of materials featuring high conductibility and workability, such as graphite, aluminum and stainless steel. The coupling surface of the bipolar plate is provided with a flow channel for guiding fuel and allowing preset reacting gas (e.g. hydrogen and oxygen) to reach a gas diffusion layer arranged between the bipolar plates and to enter into a catalyst layer, generating current through a chemical conversion reaction. The bipolar plate can also conduct current externally to a preset circuit.

However, the bipolar plate is solidly coupled to the gas diffusion layer, so the coupling surface must be processed precisely to ensure the intended air-tightness, leading to much higher processing costs, greater risk for defects, and poorer economic efficiency. Even if the coupling surface reaches the intended precision, the local stress generated by the pressure points of fittings (e.g. bolts and rivets) may lead to warping and deformation of the coupling surface when a plurality of bipolar plates and gas diffusion layers are overlapped and fastened. So, the solid coupling surface of the bipolar plate and gas diffusion layer may yield a gap or clearance notwithstanding the slight deformation. The flow channel for the bipolar plate is separated depending upon different properties of preset fuels gases (e.g hydrogen and oxygen), so the gases can flow along the preset channel to generate the correct electrochemical reaction. Thus, air-tightness of the coupling surface is a crucial element to the separation of flow channels of different gases. As mentioned above, when the coupling surface generates a clearance, the gases of different properties will be mixed before reaching the gas diffusion layer, possibly leading to a negative influence on the generating efficiency of fuel cells or even an explosion hazard due to the contact reaction of excess fuels with different properties. So, this is an important issue to be addressed for the sealing structure of a bipolar plate of a fuel cell.

For this reason, a gasket is developed to be located between the coupling surfaces of the bipolar plate and gas diffusion layer for the desirable air-tightness. When the gasket is assembled onto the bipolar plate and gas diffusion layer, the gasket made of soft material will yield to deformation under pressure. An optimum air-tightness effect could be achieved if the deformation is controlled to an exact preset value. But, owing to the lack of measures for accurately controlling the pressure state of the gasket, the gasket will be prone to quick degradation and hardening, resulting in a shorter service life.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the unique concave surface, when the bipolar plate, gas guidance and reaction layer and gasket of the fuel cell are fastened, the deformation amount of the gasket is accurately controlled through the height limitation of the concave surface. The air-tightness effect of the gasket is optimized, and the service life is greatly prolonged. Meanwhile, with the mating of concave surface, the locating state of the gasket is more stable for improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled sectional view of the present invention.

FIG. 2 shows an exploded perspective view of the present invention.

FIG. 3 shows a partially exploded sectional view of the present invention.

FIG. 4 shows a partially assembled sectional view of the present invention.

FIG. 5 shows a partial isolated and exploded perspective view of the application of the concave surface of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

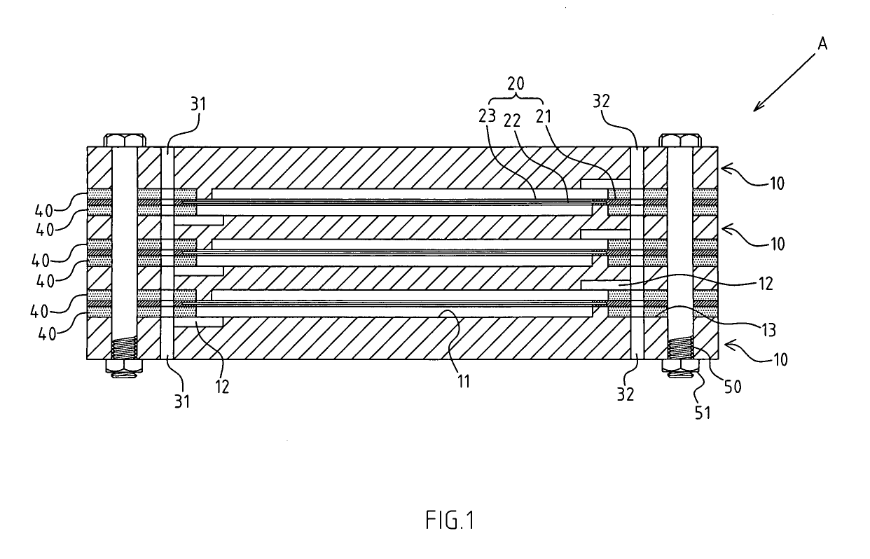

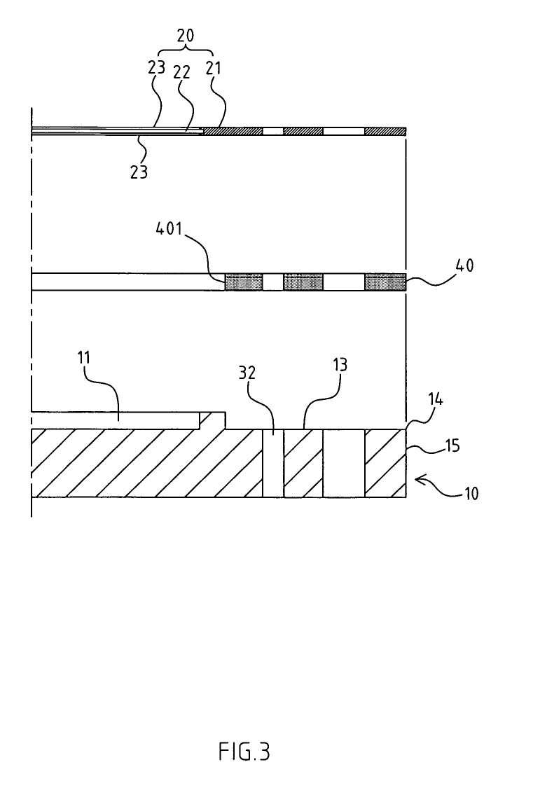

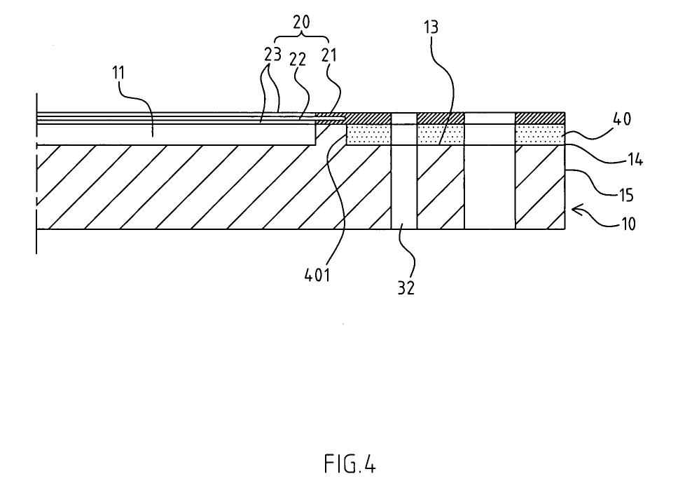

FIGS. 1-4 depict preferred embodiments of the bipolar plate's sealing structure of a fuel cell of the present invention. The embodiments are only provided for explanatory purposes with respect to the patent claims.

The fuel cell A comprises a plurality of bipolar plates 10, and a gas guidance and reaction layer 20 overlapped with the bipolar plates 10. Gas channel 11 is placed laterally onto the bipolar plates 10 corresponding to the gas guidance and reaction layer 20. The gas channel 11 has a serpentine pattern.

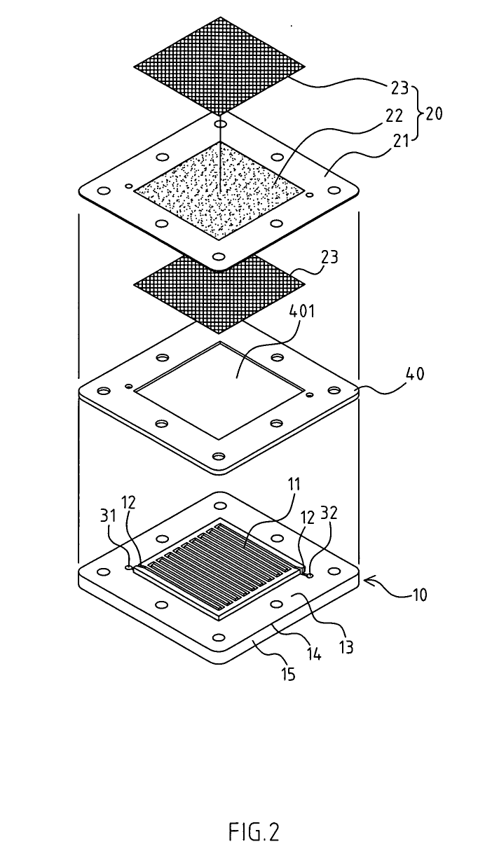

The first main gas channel 31 and second main gas channel 32 are arranged on the bipolar plates 10 at a distance from the gas channel 11. Different reacting gases, such as hydrogen and oxygen, are guided separately. The first and second main gas channels 31, 32 are connected with the gas channel 11 via a passage 12. The gasket 40 is placed between the bipolar plates 10 and gas guidance and reaction layer 20. Referring to FIG. 2, the gasket 40 is made of rubber or silica gel featuring air-tightness. When the bipolar plates 10 and gas guidance and reaction layer 20 are mated and fastened, the gasket 40 realizes an air-tight connection. Moreover, a permeable portion 401 is formed on the gasket 40 corresponding to the gas channel 11 of the bipolar plates 10.

The concave surface 13 is placed laterally on the bipolar plates 10 corresponding to the gas guidance and reaction layer 20. The concave surface 13 is properly positioned for mating with the gasket 40. In practice, the depression height of the concave surface 13 is slightly smaller than the thickness of the gasket 40. When the bipolar plates 10 and gas guidance and reaction layer 20 are coupled to yield a pressure on the gasket 40, the limited height of the concave surface 13 allows the gasket 40 to be accurately controlled to realize optimum elastic force, air-tightness effect and strong endurance.

FIGS. 1 and 2 depict the structural composition of the gas guidance and reaction layer 20, which comprises a enclosure frame 21, a membrane electrode assembly 22 located on the preset central location of the enclosure frame 21, and gas diffusion layer 23 at both sides of the membrane electrode assembly 22.

Referring to FIG. 1, a plurality of bipolar plates 10, gas guidance and reaction layer 20 and gasket 40 can be fastened securely through a bolt 50 and nut 51.

Referring to FIGS. 2, 3, and 4, the flange 14 of the concave surface 13 is used for connecting the external side 15 of the bipolar plates 10.

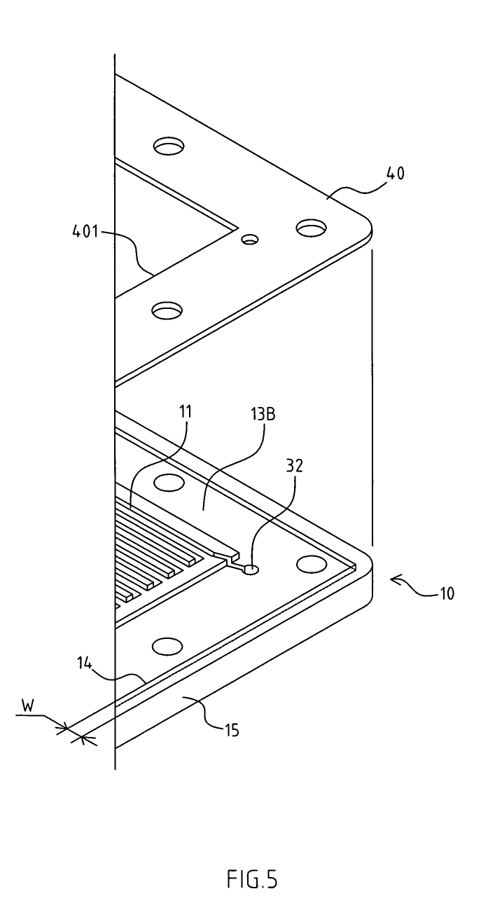

Referring to FIG. 5, the flange 14 of the concave surface 13B has a spacing W with the external side 15 of the bipolar plates 10.

Based upon above-specified structures, the present invention is operated as follows:

Referring to FIG. 1, when the fuel cell A is operated, different gases (e.g. hydrogen, oxygen) can be guided from the first or second main gas channels 31, 32 into gas diffusion layer 21 and membrane electrode assembly 22 via passage 12 and gas channel 11 of bipolar plates 10, thus converting the chemical energy into electric energy. With the arrangement of gasket 40, the bipolar plates 10 and gas guidance and reaction layer 20 are overlapped air-tight to ensure separate gas flow and to avoid any leakage or mixing.

We claim:

1. A sealing structure for a bipolar plate of a fuel cell, said sealing structure comprising:
a plurality of bipolar plates, said bipolar plates having at least one surface with a gas channel and a main channel connected to said gas channel;
a gas guidance and reaction layer, being overlapped with the one surface of said bipolar plates, said gas guidance and reaction layer being comprised of an enclosure frame, a membrane electrode assembly and gas diffusion layer, said gas diffusion layer positioned on both sides of said membrane electrode assembly;
a gasket, being located between said bipolar plates and said gas guidance and reaction layer and provided with a permeable portion corresponding to said gas channel; and
a concave surface, being placed laterally on the bipolar plates corresponding to said gas guidance and reaction layer, said concave surface being positioned and mated with said gasket.

2. The sealing structure defined in claim 1, wherein said concave surface has a flange connecting to an external side of one of said bipolar plates.

3. The sealing structure defined in claim 1, wherein said concave surface has a flange formed at a distance from an external side of one of said bipolar plates.
